(19) United States
(12) Patent Application Publication
(10) Pub. No.: US 2022/0376757 A1
(43) Pub. Date: Nov. 24, 2022

(54) EVENT-TRIGGERED PARTIAL UPDATE FOR REFERENCE SIGNAL BASED REPORT

(71) Applicant: QUALCOMM Incorporated, San Diego, CA (US)

(72) Inventors: Hamed PEZESHKI, San Diego, CA (US); Yan ZHOU, San Diego, CA (US); Tao LUO, San Diego, CA (US)

(21) Appl. No.: 17/328,842

(22) Filed: May 24, 2021

(51) Int. Cl. H04B 7/06; H04L 5/00; H04W 24/10; H04B 17/336; H04B 17/318

(52) U.S. Cl. CPC H04B 7/0626; H04L 5/0051; H04W 24/10; H04B 17/336; H04B 17/318; H04B 7/0639; H04B 7/063; H04B 7/0632

(57) ABSTRACT

Certain aspects of the present disclosure provide techniques for an event-triggered partial update for a reference signal (RS) report by a user equipment (UE). An example method performed by a UE may include receiving, from a network entity, a configuration for reference signal (RS) measurement based reporting of a plurality of parameters, calculating the parameters, based on RS measurements, in accordance with the configuration, detecting an event, based on a change in value of at least one of the parameters relative to a previously reported value for that parameter, and transmitting an event-triggered report with a partial update of the parameters, based on the detection.

### FIELD OF DISCLOSURE

Aspects of the present disclosure relate to wireless communications, and more particularly, to techniques for an event-triggered partial update for a reference signal (RS) report.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved efficiency for reference signal (RS) based reporting.

Certain aspects provide a method for wireless communication by a user equipment (UE). The method generally includes receiving, from a network entity, a report configuration for a plurality of parameters based on reference signal (RS) measurements, detecting an event, based on a change in value of at least one of the parameters relative to a previously reported value for that parameter, and transmitting an event-triggered report with a partial update of the parameters, based on the detection.

Certain aspects provide a method for wireless communication by a network entity. The method generally includes transmitting, to a user equipment (UE), a report configuration that includes information for the UE to provide an event-triggered report with a partial update of the parameters, based on a change in value of at least one of a plurality of parameters relative to a previously reported value for that parameter, transmitting reference signals (RS) for the UE to measure and calculate parameters based on the configuration, and receiving an event-triggered report with the partial update of the parameters from the UE.

Certain aspects provide means for, apparatus, and/or computer readable medium having computer executable code stored thereon, for performing the techniques described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a frame format for a new radio (NR) system, in accordance with certain aspects of the present disclosure.

FIG. 7 illustrates an example of channel state information (CSI) reporting, in accordance with certain aspects of the present disclosure.

FIG. 8 is a flow diagram illustrating example operations for wireless communication by a UE, in accordance with certain aspects of the present disclosure.

FIG. 9 is a flow diagram illustrating example operations for wireless communication by a network entity, in accordance with certain aspects of the present disclosure.

FIG. 10 is a call flow diagram illustrating example communications between a UE and a network entity, in accordance with certain aspects of the present disclosure.

FIG. 11 illustrates a communications device that may include various components configured to perform operations for the techniques disclosed herein, in accordance with aspects of the present disclosure.

FIG. 12 illustrates a communications device that may include various components configured to perform operations for the techniques disclosed herein, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for an event-triggered partial update for a reference signal (RS) report. For example, for CSI reporting, an event may be based on a threshold change relative to a previously-reported parameter, such as a rank indicator (RI) or channel quality indicator (CQI). In response to detecting such an event, a partial update (e.g., indicating a current value for the parameter whose change triggered the event or the change) may be reported.

For downlink semi persistent scheduling, such as voice over Internet protocol (VOIP), a UE can be configured, through a downlink (DL) downlink control information (DCI), to measure channel state information (CSI) reference signal (RS) through CSI-RS resources and to measure physical downlink shared channel (PDSCH) CSI measurements. A PDSCH based CSI report may occupy a first number of bits; a CSI-RS based CSI report may occupy a second number of bits. The total number of both reports may occupy the sum of the first number of bits and the second number of bits, which may not be necessary or may affect the reliability of the feedback signal. The present disclosure allows the UE to decide what information, from the PDSCH based CSI report, the CSI-RS based report, or both, to include in a report that satisfies robustness requirements while avoiding unnecessary bits.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (uRLLC). These services may include latency and reliability requirements. These services may also have different transmission time intervals (TTI) to meet respective quality of service (QoS) requirements. In addition, these services may co-exist in the same subframe.

### Example Wireless Communications System

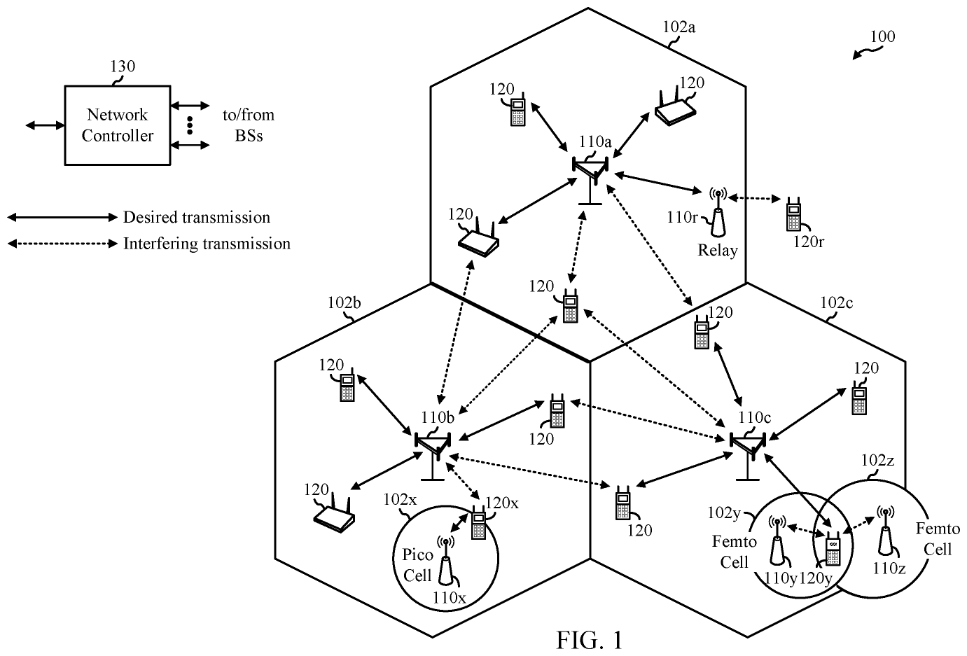

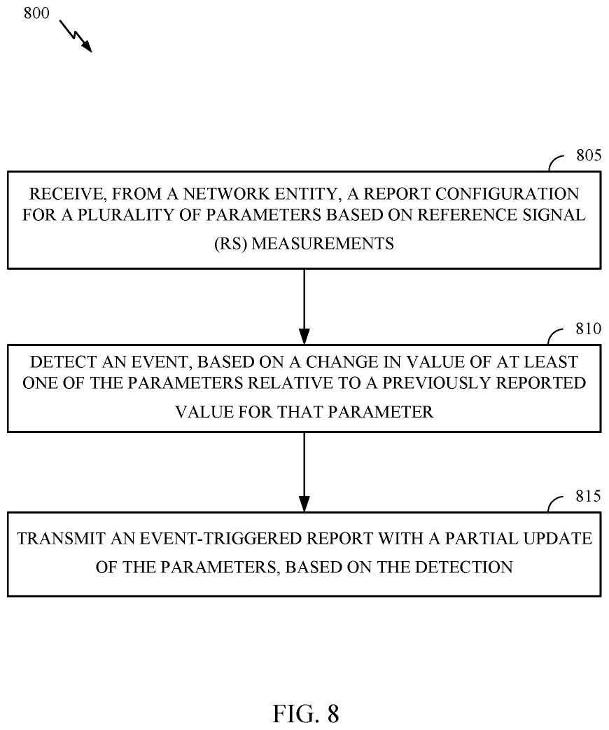

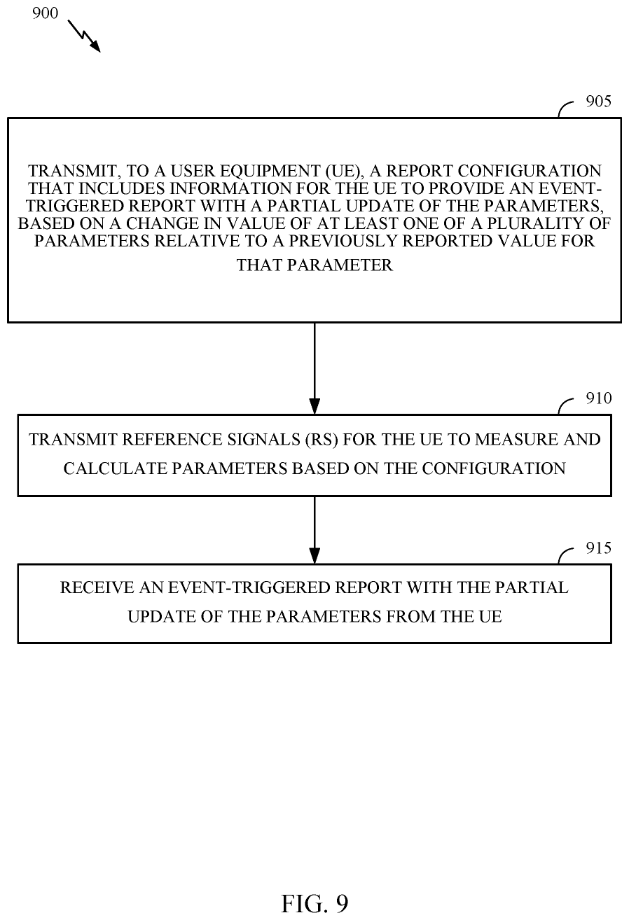

FIG. 1 illustrates an example wireless communication network 100 in which aspects of the present disclosure may be performed. For example, a UE 120 may be configured to perform operations 800 described below with reference to FIG. 8 for performing an event-triggered partial update for a reference signal (RS) report. Similarly, a base station 110 (e.g., a gNB) may be configured to perform operations 900 described below with reference to FIG. 9 to configure and process a partial update from a UE performing operations of FIG. 8.

As illustrated in FIG. 1, the wireless communication network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c,respectively. The BS 110x may be a pico BS for a pico cell 102x. The BSs 110y and 110z may be femto BSs for the femto cells 102y and 102z, respectively. ABS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using time division duplexing (TDD). Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

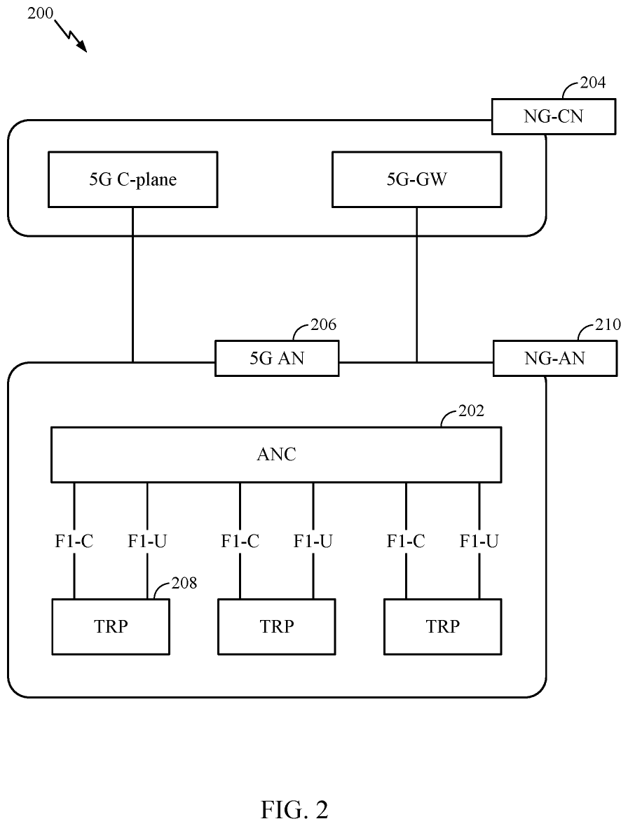

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

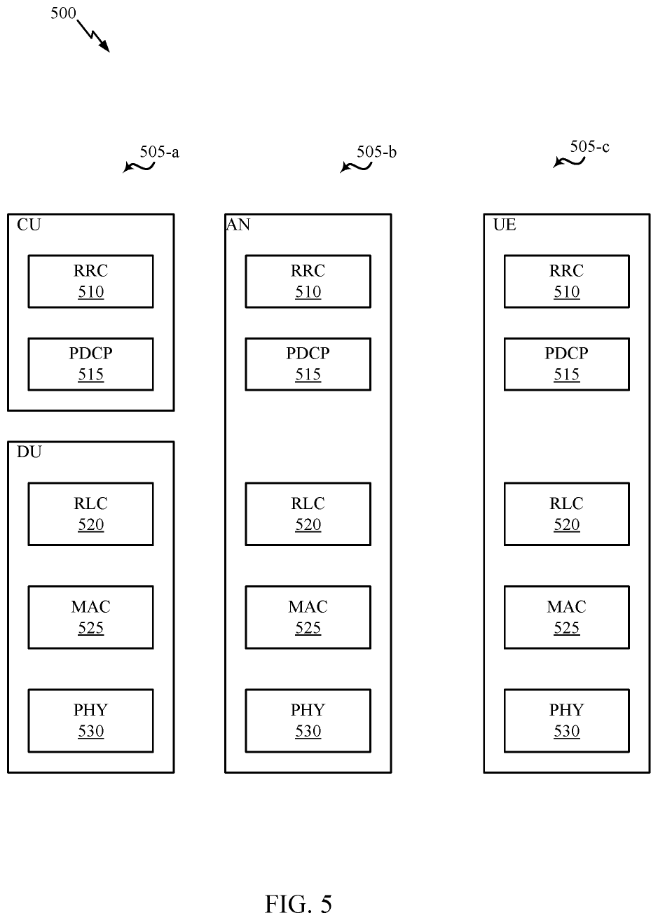

Logical functions may be dynamically distributed in the logical architecture of distributed RAN 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

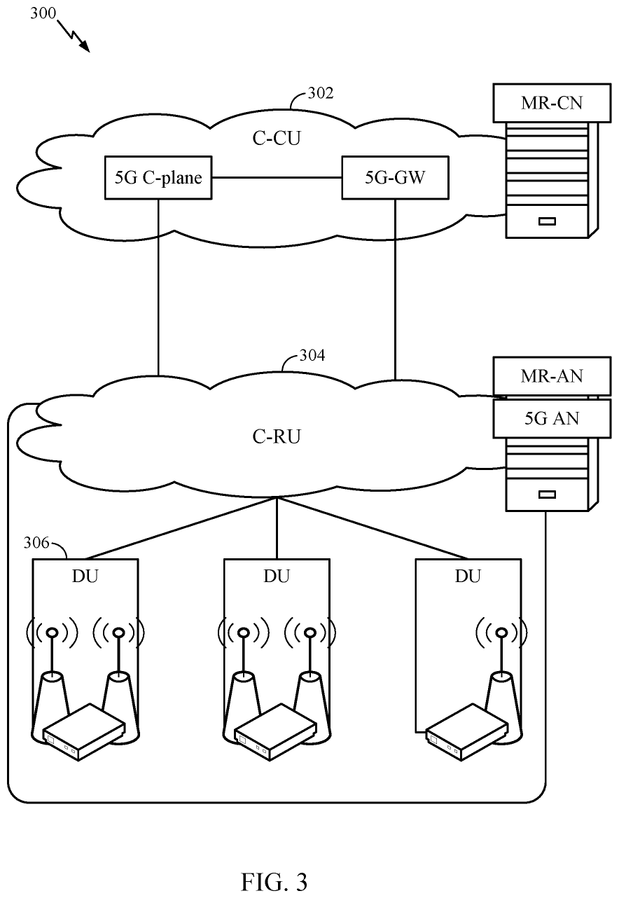

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

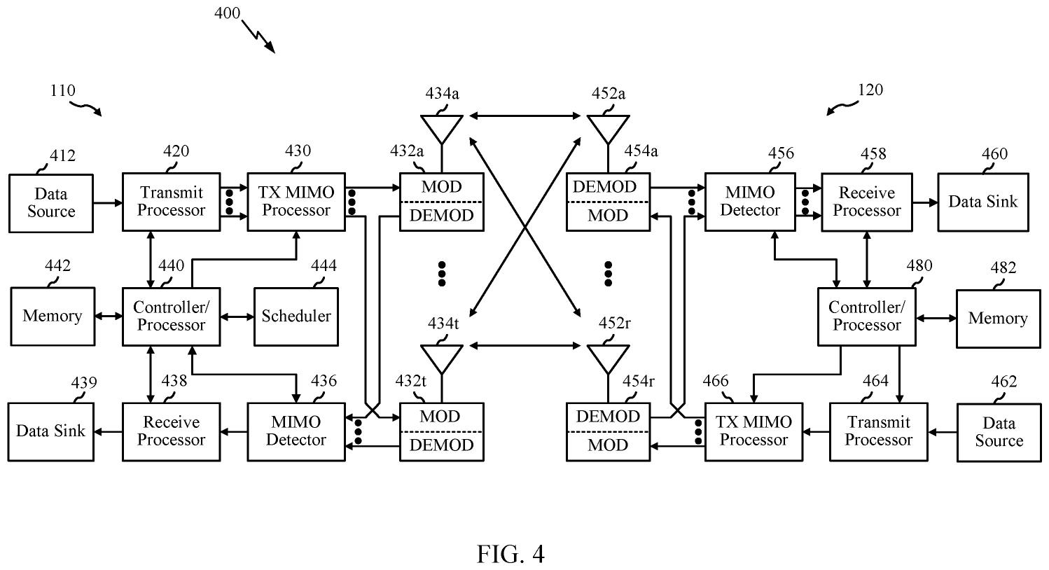

FIG. 4 illustrates example components of BS 110 and UE 120 (as depicted in FIG. 1), which may be used to implement aspects of the present disclosure. For example, antennas 452, processors 466, 458, 464, and/or controller/processor 480 of the UE 120 may be configured to perform operations 800 of FIG. 8. Similarly, antennas/processors/controllers of BS 110 may be configured to perform operations 900 of FIG. 9.

At the BS 110, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at UE 120, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r(e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the B S 110 and the UE 120, respectively. The processor 440 and/or other processors and modules at the BS 110 may perform or direct the execution of processes for the techniques described herein. The memories 442 and 482 may store data and program codes for BS 110 and UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a wireless communication system, such as a 5G system (e.g., a system that supports uplink-based mobility). Diagram 500 illustrates a communications protocol stack including a RRC layer 510, a PDCP layer 515, a RLC layer 520, a MAC layer 525, and a PHY layer 530. In various examples, the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device. In the second option, RRC layer 510, PDCP layer 515, RLC layer 520, MAC layer 525, and PHY layer 530 may each be implemented by the AN. The second option 505-b may be useful in, for example, a femto cell deployment.

Regardless of whether a network access device implements part or all of a protocol stack, a UE may implement an entire protocol stack as shown in 505-c (e.g., the RRC layer 510, the PDCP layer 515, the RLC layer 520, the MAC layer 525, and the PHY layer 530).

In LTE, the basic transmission time interval (TTI) or packet duration is the 1ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240kHz, etc. The symbol and slot lengths scale with the subcarrier spacing. The CP length also depends on the subcarrier spacing.

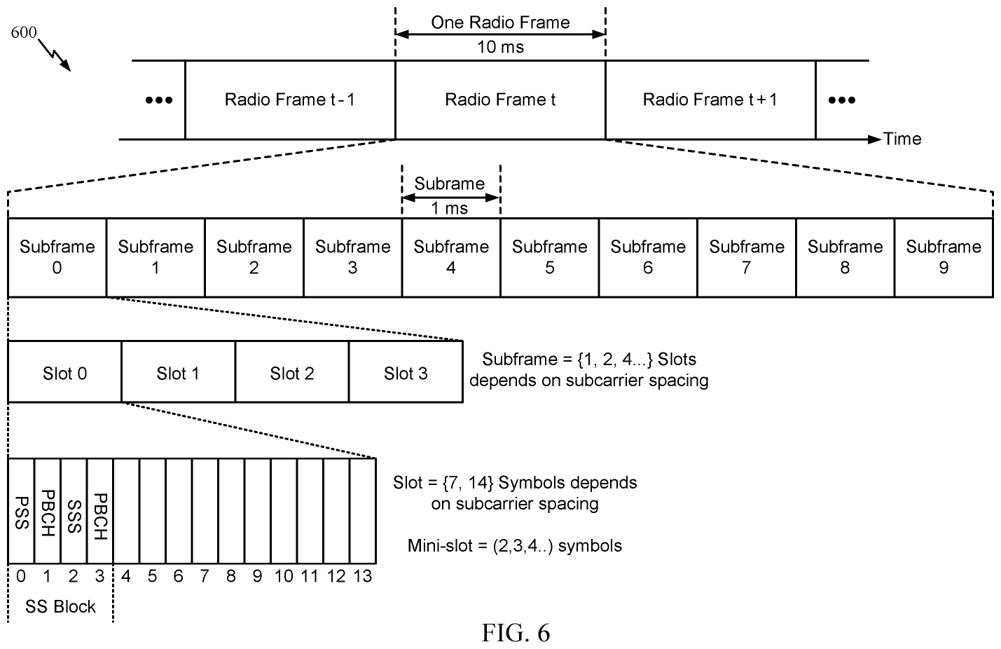

FIG. 6 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices.

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIGs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example CSI-RS Reporting

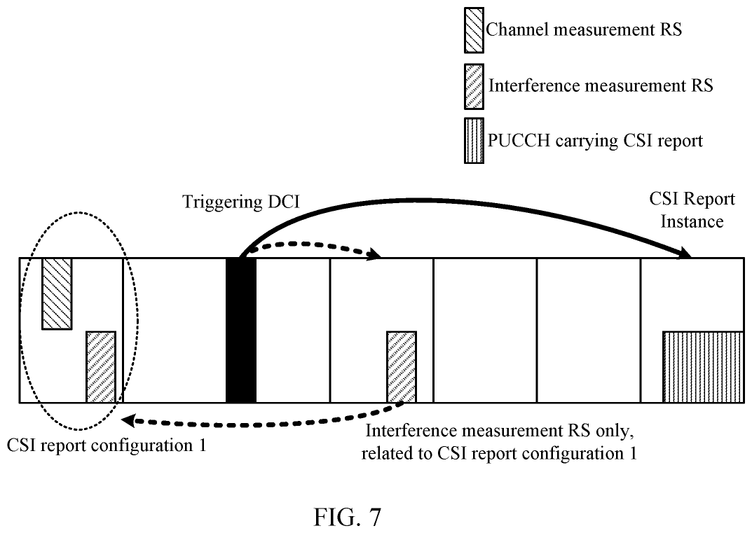

FIG. 7 is an example timeline for channel state information (CSI) reporting. In the scope of the timeline shown, it may be assumed that the UE has been configured (e.g., via CSI report configuration 1) by the network to generate CSI-RS based and PDSCH based CSI and also that the UE is enabled to select which type of CSI to report.

As illustrated in FIG. 7, the UE receives a DCI that triggers CSI-RS based CSI reporting. In some cases, the DCI may also carry a downlink grant for the PDSCH (or may trigger an SPS PDSCH). As illustrated, the CSI-RS is sent after the DCI, where an interference measurement may be performed related to the CSI report configuration 1. The UE may generate CSI based on the CSI-RS and also based on the PDSCH. The UE may then decide which type of CSI to report, for example, in a PUCCH that also carries HARQ-ACK for the PDSCH.

### Example Event-Trigger Partial Update for RS Report

Aspects of the present disclosure provide apparatus, methods, processing systems, and computer readable mediums for an event-triggered partial update for a reference signal (RS) report. For CSI reporting, an event-triggered partial update may be sent based on a threshold change relative to a previously-reported parameter, such as RI or CQI.

Channel and interference measurement(s) can be performed on different (time and frequency) resources. As noted in the CSI reporting timeline described above, a UE measures reference signal (e.g., CSI-RS), calculates parameters (e.g., RI, PMI, and CQI) based on the measurements, and sends one or more of the calculated parameters in a CSI report.

As latency requirements become more stringent, various steps may be considered to reduce CSI processing time, for example, by simplify CSI measurement and/or computation processing. In some cases, known characteristics of certain use cases may be exploited. For example, for a typical ultra-reliable low latency communication (uRLLC) and/or industrial internet of things (IIOT) scenario, the channel state may vary at a relatively slow rate, while interference may vary at a higher rate (e.g., due to unpredictable inter-cell interference variation). This may especially be the case when UE mobility is low, such as when the UE is an industrial sensor.

In such cases, since the channel may remain relatively static for periods of time, frequent channel measurement and/or reporting may not be required. In contrast, interference could contribute rather dominantly for the channel state. Therefore, interference measurement may be more useful for a CSI report to accurately capture the dynamic interference variance in a timely manner.

Thus, one option to reduce the overall CSI processing time is by reporting CSI based on interference measurement(s) only, or more frequently, such that a network entity (e.g., gNB) can obtain the CSI on time and provide a more accurate indication for modulation and coding scheme (MCS), for example.

When a CSI measurement is triggered, the UE may update the interference component for CQI generation by performing interference measurement(s) on a reference signal (RS). With respect to the channel component, previous channel measurement results can be adopted for the channel component when generating the CQI.

In this case, channel measurement and interference measurement can be effectively decoupled to some extent. For example, referring back to the example shown in FIG. 7, the DCI may trigger only the interference measurement of the RS, which is related to the latest CSI report configuration 1 including both channel part measurement and interference measurement.

Since the UE mobility is relatively low in certain cases (e.g., uRLLC and/or IIOT scenarios), the channel state with respect to the spatial domain may change rather infrequently. Therefore, for a CSI report instance, only the CQI update may be applied. In this case, a UE may provide a partial update (of CQI only) with no update for rank indicator (RI) and/or PMI. In such cases, the CSI report can be based on the previous RI and PMI instead.

Aspects of the present disclosure provide for further improvements for partial CSI reporting that may be applied to enhance the overall efficiency of CSI reporting. The improvements may enable a UE to perform an event-triggered partial update (or report) for RS measurements.

For example, for an event-triggered CSI report, the CSI may be computed based on both up-to-date interference measurement(s) and previous channel measurement(s). A partial CSI report information update (e.g., for RI, PMI, and/or CQI) for a CSI report can be applied (e.g., based on being different from a previous measurement by a threshold), while other aspects of information may be based on previous measurement(s). For example, the new channel matrix, the best rank, and the precoding matrix may remain unchanged, and only the CQI per stream changes. In this case, the UE may not need to report all the metrics (e.g., RI, PMI, and CQI), and the UE could simply report the metric(s) that has actually changed (e.g., CQI).

FIG. 8 illustrates example operations 800 for wireless communication, in accordance with certain aspects of the present disclosure. Operations 800 may be performed, for example, by UE (e.g., such as a UE 120 in the wireless communication network 100) configured to perform partial event-triggered RS reporting.

The operations 800 begin, at 805, by receiving, from a network entity, a report configuration for a plurality of parameters based on reference signal (RS) measurements. For example, the configuration may indicate CSI-RS resources for channel measurement (CM) and interference measurement (IM).

At 810, the UE detects an event, based on a change in value of at least one of the parameters relative to a previously reported value for that parameter. At 815, the UE transmits an event-triggered report with a partial update of the parameters, based on the detection. For example, the UE may detect a change in a calculate parameter above a threshold value and, in response, send a partial update RS report (indicating the value of the parameter whose changed triggered the report or the changed value itself).

FIG. 9 illustrates example operations 900 for wireless communications by a network entity that may be considered complementary to operations 800 of FIG. 8. For example, operations 900 may be performed by a base station (e.g., the BS 110a of FIG. 1) to configure and process an event-triggered partial update RS report from a UE performing operations 800 of FIG. 8.

Operations 900 begin, at 905, by transmitting, to a user equipment (UE), a report configuration that includes information for the UE to provide an event-triggered report with a partial update of the parameters, based on a change in value of at least one of a plurality of parameters relative to a previously reported value for that parameter.

At 910, the network entity transmits reference signals (RS) for the UE to measure and calculate parameters based on the configuration. At 915, the network entity receives an event-triggered report with the partial update of the parameters from the UE.

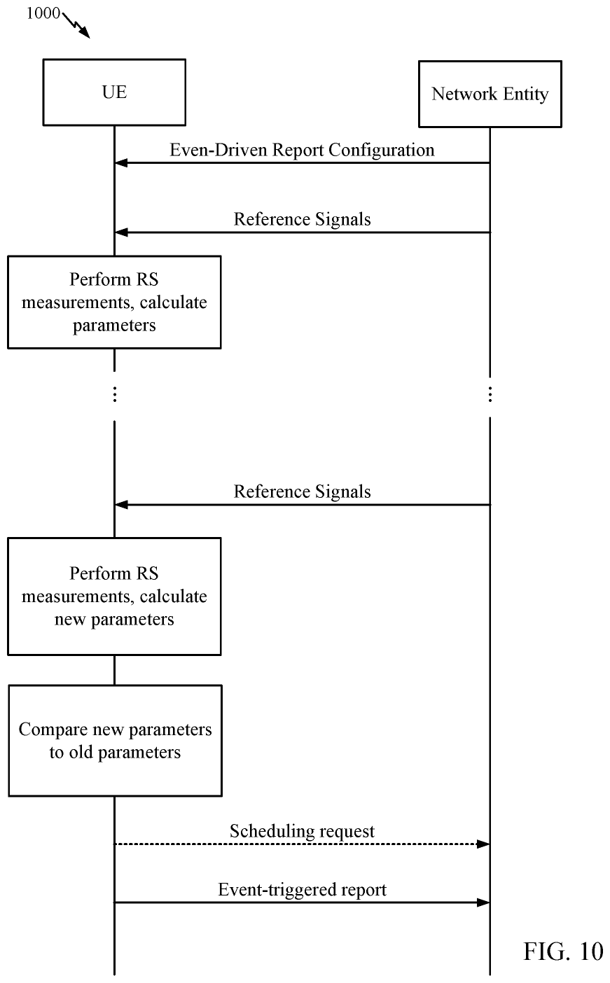

Operations 800 and 900 of FIGS. 8 and 9 may be understood with reference to FIG. 10, which call flow diagram 1000 illustrating example communications between a UE (e.g., the UE 120 of FIG. 1) and a network entity (e.g., the BS 110a of FIG. 1). The example assumes that the UE has been configured by the network to generate CSI-RS based and PDSCH based CSI and also that the UE is enabled to select which type of CSI to report.

As shown in FIG. 10, the gNB may configure the UE for event-driven reporting as described above. The gNB then transmit reference signals (e.g., CSI-RS or other type RS) and the UE performs measurements on such reference signals, as well as calculating a current set of parameters (e.g., RI, PMI, and/or CQI).

The UE receives more reference signals and performs second (new) measurements and calculations to determine a new set of parameters. As shown, the UE then compares the new parameters to the old (current) parameters (e.g., based on consecutive measurements).

As described above, such comparison may include determining whether any of the new parameters are different from a corresponding one of the old parameters. As shown, the UE transmits an event-triggered report to the network entity based on any of the new parameters being different from the old parameters (e.g., by a threshold value). In some cases, the UE may report none of the second set of metrics if none of such metrics have changed (e.g., by a threshold value). In some cases, as shown, when the UE is to send the event-triggered report, the UE may optionally send a scheduling request (SR) to the network entity prior to sending the event-triggered report.

In certain aspects, for an event-triggered partial update for an RS report, every time the UE has CSI-RS (or another RS) to measure, when the measurement for that occasion is done, parameters/metrics (e.g., RI, PMI, CQI) may be calculated. If there is no change in the parameters/metrics with respect to a previous report occasion, then the UE may determine to not send any update (e.g., a report).

Alternatively, if one or more parameters have changed with respect to the previous report occasion (e.g., by a threshold), then the UE can initiate and transmit an event-triggered report. That is, when one or more of the parameters/metrics have changed, the reporting event is triggered.

The manner in which the event-triggered report is sent may be configured in a variety of ways. In some cases, the UE may send a scheduling request SR for an uplink grant to send the report (e.g., the report can be carried on uplink control information (UCI) and/or media access (MAC) control element (CE)). In some cases, the report can be included in an acknowledgement (ACK) or negative ACK (NACK) response.

In some examples, periodic reporting resources may be configured (e.g., periodic physical uplink control channel (PUCCH) and/or physical uplink shared channel (PUSCH) resources), and the UE may only report when any given metric has changed (otherwise the resource may be void/empty if no reporting occurs).

In certain aspects, the event-triggered partial update can be applied in other contexts (other type of RS-based reporting) besides the CSI-RS example described above. For example, the techniques may be applied to a layer 1 (L1) reference signal received power (RSRP) and/or a L1 signal-to-noise and interference ratio (SINR) based reporting for beam management. In such cases, if the variation with respect to an earlier reported value for L1-RSRP and/or L1-SINR for a given beam is larger than a threshold, sending the L1-RSRP and/or L1-SINR report(s) would be triggered.

In some cases, the threshold may be configured by the gNB. In some cases, the UE may be configured with a set of threshold values and one of the set of threshold values may be indicated (e.g., via a MAC CE or DCI).

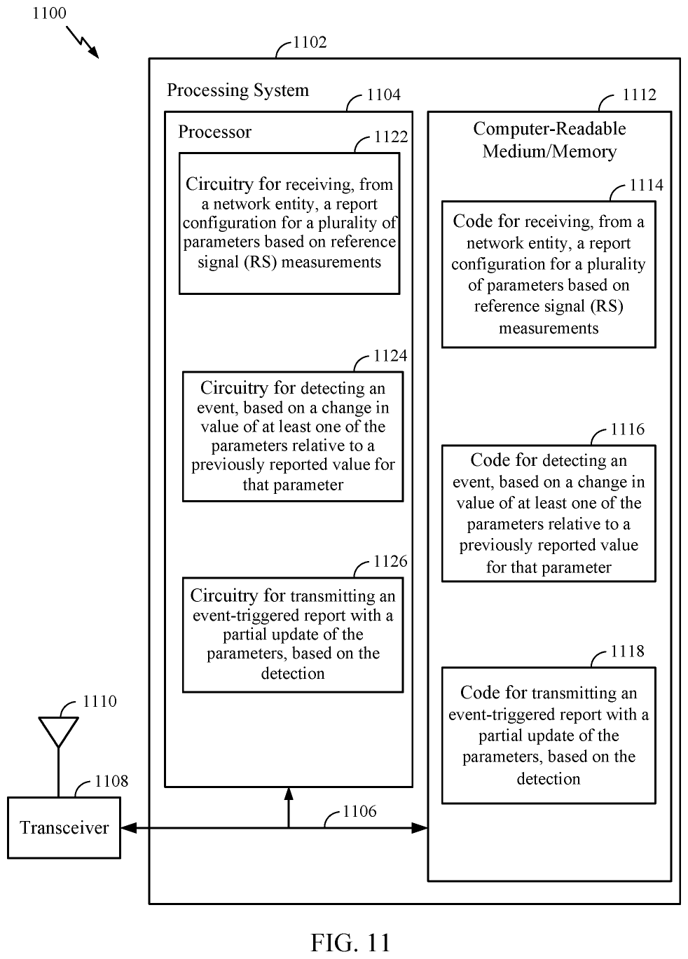

FIG. 11 illustrates a communications device 1100 that may include various components (e.g., corresponding to means-plus-function components) configured to perform operations for the techniques disclosed herein, such as the operations illustrated in FIG. 8. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 8, or other operations for performing the various techniques discussed herein for SSBs in different frequency intervals in NTN. In certain aspects, computer-readable medium/memory 1112 stores code 1114 for receiving, from a network entity, a configuration for RS measurement based reporting of a plurality of parameters; code 1116 for calculating the parameters, based on RS measurements, in accordance with the configuration; code 1118 for detecting an event, based on a change in value of at least one of the parameters relative to a previously reported value for that parameter; and code 1120 for transmitting an event-triggered report with a partial update of the parameters, based on the detection. In certain aspects, the processor 1104 has circuitry configured to implement the code stored in the computer-readable medium/memory 1112. The processor 1104 includes circuitry 1124 for receiving, from a network entity, a configuration for RS measurement based reporting of a plurality of parameters; code 1116 for calculating the parameters, based on RS measurements, in accordance with the configuration; code 1118 for detecting an event, based on a change in value of at least one of the parameters relative to a previously reported value for that parameter; and code 1120 for transmitting an event-triggered report with a partial update of the parameters, based on the detection.

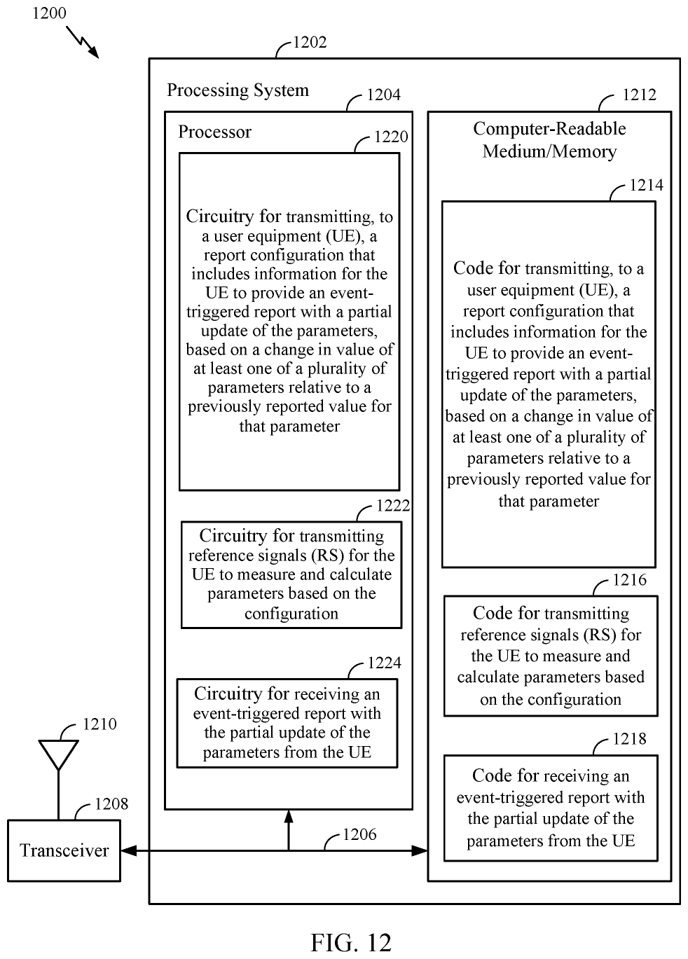

FIG. 12 illustrates a communications device 1200 that may include various components (e.g., corresponding to means-plus-function components) configured to perform operations for the techniques disclosed herein, such as the operations illustrated in FIG. 9. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 9, or other operations for performing the various techniques discussed herein for SSBs in different frequency intervals in NTN. In certain aspects, computer-readable medium/memory 1212 stores code 1214 for transmitting, to a UE, a configuration for RS measurement based reporting of a plurality of parameters, wherein the configuration includes information for the UE to provide an event-triggered report with a partial update of the parameters, based on a detection of an event by the UE based on a change in value of at least one of the parameters relative to a previously reported value for that parameter; code 1216 for transmitting RS for the UE to measure and calculate parameters based on the configuration; and code 1218 for receiving an event-triggered report with the partial update of the parameters from the UE. In certain aspects, the processor 1204 has circuitry configured to implement the code stored in the computer-readable medium/memory 1212. The processor 1204 includes circuitry 1220 for transmitting, to a UE, a configuration for RS measurement based reporting of a plurality of parameters, wherein the configuration includes information for the UE to provide an event-triggered report with a partial update of the parameters, based on a detection of an event by the UE based on a change in value of at least one of the parameters relative to a previously reported value for that parameter; circuitry 1222 for transmitting RS for the UE to measure and calculate parameters based on the configuration; and circuitry 1224 for receiving an event-triggered report with the partial update of the parameters from the UE.

### EXAMPLE ASPECTS

Aspect 1. A method of wireless communications by a user equipment (UE), comprising receiving, from a network entity, a report configuration for a plurality of parameters based on reference signal (RS) measurements; detecting an event, based on a change in value of at least one of the parameters relative to a previously reported value for that parameter; and transmitting an event-triggered report with a partial update of the parameters, based on the detection.

Aspect2. The method of Aspect 1, wherein the partial update of the parameters includes at least the changed value of the at least one parameter for which the event was detected.

Aspect 3. The method of Aspect1 or 2, wherein the RS comprises CSI-RS.

Aspect 4. The method of any of Aspects 1-3, wherein the parameters comprise rank indication (RI), precoding matrix indicator (PMI), and a channel quality indicator (CQI).

Aspect 5. The method of any of Aspects 1-4, wherein the parameters comprise at least one of a layer 1 (L1) reference signal received power (L1-RSRP) or L1 signal to interference and noise ratio (L1-SINR); and detecting the event comprises detecting that a change in value of at least one of L1-RSRP or L1-SINR for a certain beam has changed more than a threshold amount, relative to a previously reported value.

Aspect 6. The method of any of Aspects 1-5, further comprising transmitting the network entity a scheduling request (SR) to request uplink resources to transmit the report.

Aspect 7. The method of any of Aspects 1-6, wherein the report is conveyed via uplink control information (UCI) or a medium access control (MAC) control element (CE).

Aspect 8. The method of any of Aspects 1-7, wherein the report is multiplexed with acknowledgment feedback.

Aspect 9. The method of any of Aspects 1-8, wherein the UE is configured with periodic resources for transmitting the report.

Aspect 10. The method of Aspect 9, wherein the periodic resources are used to transmit the report only when the event is detected.

Aspect 11. A method of wireless communications by a network entity, comprising transmitting, to a user equipment (UE), a report configuration that includes information for the UE to provide an event-triggered report with a partial update of the parameters, based on a change in value of at least one of a plurality of parameters relative to a previously reported value for that parameter; transmitting reference signals (RS) for the UE to measure and calculate parameters based on the configuration; and receiving an event-triggered report with the partial update of the parameters from the UE.

Aspect 12. The method of Aspect 11, wherein the partial update of the parameters includes at least the changed value of the at least one parameter for which the event was detected.

Aspect 13. The method of Aspect 11 or 12, wherein the RS comprises CSI-RS.

Aspect 14. The method of any of Aspects 11-13, wherein the parameters comprise rank indication (RI), precoding matrix indicator (PMI), and a channel quality indicator (CQI).

Aspect 15. The method of any of Aspects 11-14, wherein the parameters comprise at least one of a layer 1 (L1) reference signal received power (L1-RSRP) or L1 signal to interference and noise ratio (L1-SINR); and the event comprises a change in value of at least one of L1-RSRP or L1-SINR for a certain beam has changed more than a threshold amount, relative to a previously reported value.

Aspect 16. The method of any of Aspects 11-15, further comprising receiving a scheduling request (SR) from the UE for uplink resources to transmit the report; and granting uplink resources for the UE to transmit the report in response to the SR.

Aspect 17. The method of any of Aspects 11-16, wherein the report is conveyed via uplink control information (UCI) or a medium access control (MAC) control element (CE).

Aspect 18. The method of any of Aspects 11-17, wherein the report is multiplexed with acknowledgment feedback.

Aspect 19. The method of any of Aspects 11-18, further comprising configuring the UE with periodic resources for transmitting the report.

Aspect 20. The method of Aspect 19, wherein the periodic resources are used to transmit the report only when a change in value of at least one of the parameters is detected.

Aspect 21: An apparatus, comprising: a memory comprising executable instructions; and one or more processors configured to execute the executable instructions and cause the apparatus to perform a method in accordance with any one of Aspects 1-20.

Aspect 22: An apparatus, comprising means for performing a method in accordance with any one of Aspects 1-20.

Aspect 23: A non-transitory computer-readable medium comprising executable instructions that, when executed by one or more processors of an apparatus, cause the apparatus to perform a method in accordance with any one of Aspects 1-20.

Aspect 24: A computer program product embodied on a computer-readable storage medium comprising code for performing a method in accordance with any one of Aspects 1-20.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of ”a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. For example, operations shown in FIG. 8 may be performed by one or more processors of the UE 120 shown in FIG. 4, while operations shown in FIG. 9 may be performed by one or more processors of the BS 110 shown in FIG. 4.

A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 8-10.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of wireless communications by a user equipment (UE), comprising:
receiving, from a network entity, a report configuration for a plurality of parameters based on reference signal (RS) measurements;
detecting an event, based on a change in value of at least one of the parameters relative to a previously reported value for that parameter; and
transmitting an event-triggered report with a partial update of the parameters, based on the detection.

2. The method of claim 1, wherein the partial update of the parameters includes at least the changed value of the at least one parameter for which the event was detected.

3. The method of claim 1, wherein the RS comprises CSI-RS.

4. The method of claim 1, wherein the parameters comprise rank indication (RI), precoding matrix indicator (PMI), and a channel quality indicator (CQI).

5. The method of claim 1, wherein:
the parameters comprise at least one of a layer 1 (L1) reference signal received power (L1-RSRP) or L1 signal to interference and noise ratio (L1-SINR); and
detecting the event comprises detecting that a change in value of at least one of L1-RSRP or L1-SINR for a certain beam has changed more than a threshold amount, relative to a previously reported value.

6. The method of claim 1, further comprising transmitting the network entity a scheduling request (SR) to request uplink resources to transmit the report.

7. The method of claim 1, wherein the report is conveyed via uplink control information (UCI) or a medium access control (MAC) control element (CE).

8. The method of claim 1, wherein the report is multiplexed with acknowledgment feedback.

9. The method of claim 1, wherein the UE is configured with periodic resources for transmitting the report.

10. The method of claim 9, wherein the periodic resources are used to transmit the report only when the event is detected.

11. A method of wireless communications by a network entity, comprising:
transmitting, to a user equipment (UE), a report configuration that includes information for the UE to provide an event-triggered report with a partial update of the parameters, based on a change in value of at least one of a plurality of parameters relative to a previously reported value for that parameter;
transmitting reference signals (RS) for the UE to measure and calculate parameters based on the configuration; and
receiving an event-triggered report with the partial update of the parameters from the UE.

12. The method of claim 11, wherein the partial update of the parameters includes at least the changed value of the at least one parameter for which the event was detected.

13. The method of claim 11, wherein the RS comprises CSI-RS.

14. The method of claim 11, wherein the parameters comprise rank indication (RI), precoding matrix indicator (PMI), and a channel quality indicator (CQI).

15. The method of claim 11, wherein:
the parameters comprise at least one of a layer 1 (L1) reference signal received power (L1-RSRP) or L1 signal to interference and noise ratio (L1-SINR); and
the event comprises a change in value of at least one of L1-RSRP or L1-SINR for a certain beam has changed more than a threshold amount, relative to a previously reported value.

16. The method of claim 11, further comprising:
receiving a scheduling request (SR) from the UE for uplink resources to transmit the report; and
granting uplink resources for the UE to transmit the report in response to the SR.

17. The method of claim 11, wherein the report is conveyed via uplink control information (UCI) or a medium access control (MAC) control element (CE).

18. The method of claim 11, wherein the report is multiplexed with acknowledgment feedback.

19. The method of claim 11, further comprising configuring the UE with periodic resources for transmitting the report.

20. The method of claim 19, wherein the periodic resources are used to transmit the report only when a change in value of at least one of the parameters is detected.
